(19) United States
(12) Patent Application Publication
(10) Pub. No.: US 2025/0103176 A1
(43) Pub. Date: Mar. 27, 2025

(54) MULTI-INDICATOR INPUT DEVICE

(71) Applicant: Hewlett-Packard Development Company, L.P., Spring, TX (US)

(72) Inventors: J MICHAEL STAHL, Fort Collins, CO (US); BRYAN MICHAEL HECKMAN, Fort Collins, CO (US); DANIEL EDWARD ALLEN, Fort Collins, CO (US); DYLAN JAMES LEA, Fort Collins, CO (US); JOSEPH-JONATHAN SALZANO, Fort Collins, CO (US); MATTHEW TIMOTHY BRADOW, Fort Collins, CO (US); PETER ANDREW SEILER, Fort Collins, CO (US)

(73) Assignee: Hewlett-Packard Development Company, L.P., Spring, TX (US)

(21) Appl. No.: 18/471,804

(22) Filed: Sep. 21, 2023

(51) Int. Cl. G06F 3/04812; G06F 3/02; G06F 3/0354; G06F 3/0487

(52) U.S. Cl. CPC G06F 3/04812; G06F 3/02; G06F 3/03543; G06F 3/0487

(57) ABSTRACT

A device may receive a first user interaction signal in response to a first user interaction with a first user interaction element. In response to the first user interaction signal, the device may provide a first instruction to the computing system to perform a first action with respect to the first indicator, wherein the first indicator is active. The device may receive a switch control signal in response to a second user interaction with a switch control element. The device may set the first indicator as the inactive indicator and the second indicator as the active indicator. The device may receive a second user interaction signal in response to a third user interaction with the first user interaction element and use the second controller to provide a second instruction to the computing system to perform a second action with respect to the second indicator.

### BACKGROUND

Artists, editors, professionals, or other users of computing systems frequently utilize more than one application or program at a time. In addition, applications or program windows may be open on separate displays of the computing system, requiring users to navigate a single cursor across multiple displays using an input device (e.g., a mouse a trackpad, or a stylus). For example, a user may desire to copy and paste a block of text from a first application to a second application that are open on separate displays. To do so, the user interacts with the block of text on the first application with a cursor, drag the cursor to the second application, and interact with the second application to paste. This process may result in user fatigue from manual navigation and reduce efficiency.

### BRIEF DESCRIPTION OF THE DRAWINGS

Various features will now be described with reference to the following drawings Throughout the drawings, reference numbers may be re-used to indicate correspondence between referenced elements. The drawings are provided to illustrate examples described herein and are not intended to limit the scope of the disclosure.

FIG. 1 illustrates a block diagram of an input device that manages and controls multiple indicators displayed on a computing system in accordance with certain embodiments.

FIG. 2 illustrates an input device that uses multiple controllers to control multiple indicators on a display of a computing system in accordance with certain embodiments.

FIG. 3 illustrates an example input device that includes a single controller to control multiple indicators on a display of a computing system in accordance with certain embodiments.

FIG. 4 presents a flowchart of an example active indicator control process in accordance with certain embodiments.

FIG. 5 presents a flowchart of an example active indicator switching process in accordance with certain embodiments.

### DETAILED DESCRIPTION

Users of computing systems may frequently interact with one or more applications spread across multiple displays of a computing system using a single indicator (e.g., a cursor). Movement or control of the indicator can result in user fatigue, such as arm or hand fatigue, from manually operating the input device, particularly when controlling the cursor across multiple displays. In addition, time may be lost from dragging or locating an indicator between displays. Some of the aforementioned challenges can be addressed by using a system that can control and switch between multiple indicators via a single input device.

Aspects of the present disclosure relate to systems and methods for controlling, via a single input device, multiple indicators on a display or multiple displays of a computing system. In some embodiments, an input device may be configured to identify and control an active indicator of a plurality of indicators on the display of a computing system. Further, the input device may be configured to receive a switch control signal to switch the selection of an active indicator. The ability to select an active indicator using the input device enables a user of the input device to quickly and seamlessly toggle between indicators that are located on separate areas of the computing system without disrupting the workflow. In some examples, a cursor may be designated or locked to a specific bounded area of the display or an application window to further streamline efficiency. The restriction of a cursor to a particular bounded area may be determined automatically, by an application, or by a user.

### Example Computing Environment

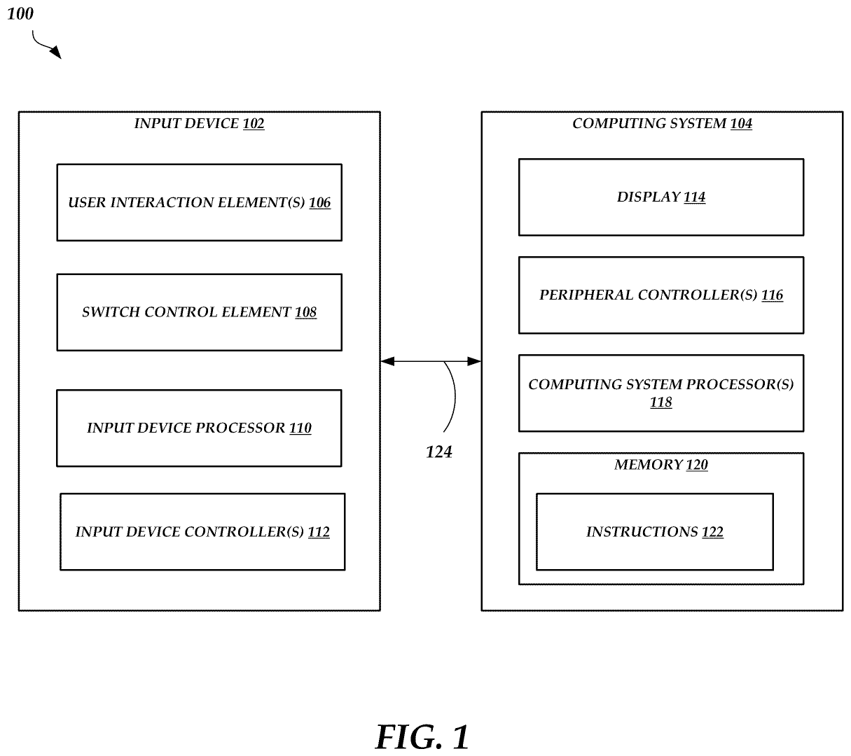

FIG. 1 illustrates a block diagram of an input device 102 that manages and controls multiple indicators displayed on a computing system 104 within computing environment 100. The computing environment 100 includes the input device 102 and the computing system 104.

An indicator may refer to a graphical element that appears on a display 114 of the computing system 104. For example, an indicator may include a cursor, a pointer, a text insertion indicator, an icon, a hand, a tool, a white cross cursor, an arrow, a paintbrush, a scroll cursor, and the like. In some embodiments, an indicator may be controlled by the input device 102 of computing environment 100. For example, the input device 102 may control an indicator's movement or location on the display 114, an action associated with the indicator's location (e.g., copying data at the indicator location to a clipboard), functionality, and the like.

The input device 102 may include any device capable of communicating interaction signals to the computing system 104. For example, the input device 102 may include a mouse, a trackpad, a stylus, a light pen, a track ball, a joystick, a tablet, a scanner, a digitizer, a mobile device, a keyboard, and the like. As shown in FIG. 1, the input device 102 includes one or more user interaction element(s) 106, a switch control element 108, one or more input device controller(s) 112, and an input device processor 110.

In some embodiments, the user interaction element(s) 106 may include any type of component or interface configured to receive or facilitate user interaction with the input device 102. For example, the user interaction element(s) 106 may include a button, a touch-sensitive surface (such as a trackpad or touchscreen, etc.), a track ball, a joystick, a pen tip, and the like. In some embodiments, an interaction signal is a signal (e.g., an electrical or digital signal) generated by a user interface element in response to a user interaction with the user interface element(s) 106. For example, the signal may be generated in response to a click, a movement, a swipe, a drag, a roll, a gesture, etc. using the user interaction element(s) 106 of the input device 102. In some cases, the user interaction element(s) 106 may be used to control an indicator of the computing system 104. For example, a user may press a button to perform a click action of a cursor on the display 114 of the computing system 104. The gesture may refer to movement of the input device 102 in a particular pattern. Alternatively, the gesture may refer to movement of a body part of a user. For instance, the input device 102 and/or computing system 104 may include a camera capable of detecting hand, face, body, etc. movement indicative of an intent to select or interact with the input device 102 or an indicator controlled by the input device 102.

In some embodiments, the switch control element 108 may include any type of component or interface configured to receive or facilitate user interaction related to switching control or selection of an indicator. For example, the switch control element 108 may include a button, a touch-sensitive surface (such as a trackpad or touchscreen, etc.), a track ball, a joystick, a pen tip, etc. In some embodiments, the input device 102 may include a number of switch control elements 108 corresponding to the number of indicators. For example, the switch control element 108 may include a number of buttons with each button corresponding to a particular indicator. In this example, a user may press the button corresponding to the desired indicator to switch control, or to select, the particular desired indicator. Alternatively, the input device 102 may include the switch control element 108 to toggle between indicators. In yet other implementations, the input device 102 may include a “back and forth” button, or a pair of buttons with one corresponding to “back” and one corresponding to “forward” for toggling through indicators in a forward or backward direction. In some embodiments, switch control element 108 is an element separate from the user interaction element(s) 106. In some embodiments, the switch control element 108 may be an element or device configured to receive an interaction corresponding to switching control of an indicator. For example, a user may provide a voice command, perform a gesture, or a gaze at a particular location to trigger the switch control element 108. In some embodiments, the switch control element 108 may switch the indicator that is active, e.g., the indicator that the user is currently interacting with via the user interaction element(s) 106. The one or more indicators that are not selected or being interacted with by the user may be set as inactive indicators. Although inactive, the unselected indicators may remain displayed on the display 114.

In some embodiments, the input device processor 110 may execute program instructions or modules stored in a memory or other non-transitory computer-readable storage medium or device (e.g., solid state storage devices, disk drives, etc.). In some embodiments, the input device processor 110 may execute program instructions to receive interaction signals from a user interacting with the input device 102. For example, the input device processor 110 may receive an interaction signal corresponding to an interaction with the user interaction element(s) 106 and/or the switch control element 108. In some cases, the input device processor 110 may communicate the interaction signal to the input device controller(s) 112. In some embodiments, interaction signals may be sent from the input device 102 to the computing system 104 over a closed circuit. In this case, the computing system 104 may receive the interaction signals and perform further processing on the signal to correlate control with indicator(s) on the display 114. In some cases, the interaction signals may be generated in response to the user's interaction with the user interaction element(s) 106. In cases where the interaction signals generated by the user interaction element(s) 106 are transmitted to the computing system 104 without further processing, the input device processor 110 may be optional or omitted.

In some embodiments, the input device controller(s) 112 may be configured to provide instructions to the computing system 104 to control an indicator on the display 114 of the computing system 104. In some embodiments, input device controller(s) include a USB controller, an RF controller, or a Bluetooth controller. In some cases, in response to an interaction signal, the input device controller(s) 112 may provide an instruction to the computing system 104 to perform an action with respect to an indicator. For example, the input device controller(s) 112 may receive an interaction signal from the input device processor 110 corresponding to a trackpad movement. The input device controller(s) 112 may then provide instructions to the computing system 104 to perform a cursor movement on the display 114 corresponding to the trackpad movement. In another example, input device controller(s) 112 may receive an interaction signal from the input device processor 110 corresponding to a click of a hyperlink to open a webpage, a selection of text, a copy to clipboard request, etc. In another example, the input device controller(s) 112 may receive an interaction signal from the input device processor 110 corresponding to a switch control signal to switch control of an indicator from a first indicator to a second indicator. The input device controller(s) 112 may provide an instruction to the computing system 104 to set a second indicator as an active indicator.

In some embodiments, the input device 102 includes more than one input device controller 112 configured to control more than one indicator on the display 114 of the computing system 104. For example, the input device 102 may include a first and second input device controller 112 configured to control a first and second indicator, respectively. In this example, when a first indicator is set as the active indicator, the computing system 104 may receive instructions from the first input device controller 112 to control the first indicator. Similarly, when a second indicator is set as the active indicator, the computing system 104 may receive instructions from the second input device controller 112 to control the second indicator. In some embodiments, the input device 102 may include a third, fourth, fifth, . . . . Nth input device controller to provide instructions to the computing system 104 to control a Nth indicator on the display 114.

The input device 102 may be communicatively coupled to the computing system 104 via link 124. The link 124 may be any type of connection between the input device 102 and the computing system 104, such as a wired connection. Link 124 between the input device 102 and computing system 104 is not limited to wired connections but may include wireless communication such as BLUETOOTH®, Wi-Fi®, according to an IEEE 802 standard, etc. Further, in some cases, the link 124 may be or may include a network, such as the Internet. In some cases, link 124 may be used by both the input device 102 and the computing system 104 to send and receive instructions corresponding to controlling indicator(s) on the display 114.

The computing system 104 may be an embodiment of a computing system that can execute a program or application. The computing system 104 may include any device or system capable of connecting to and communicating with the input device 102. In general, the computing system 104 can be any computing system such as a desktop, laptop or tablet computer, personal computer, wearable computer, server, personal digital assistant (PDA), hybrid PDA/mobile phone, mobile phone, electronic book reader, set-top box, voice command device, camera, digital media player, and the like. As shown in FIG. 1, the computing system 104 includes the display 114, peripheral controller(s) 116, computing system processor(s) 118, and memory 120 with instructions 122.

In some embodiments, the computing system processor(s) 118 may execute program instructions, such as the instructions 122, stored in the memory 120 or other non-transitory computer-readable storage medium or device (e.g., solid state storage devices, disk drives, etc.). In some embodiments, the computing system processor(s) 118 may provide instructions to the peripheral controller(s) 116 to control one or more indicator(s) of the computing system 104. In some embodiments, the computing system processor(s) 118 may execute program instructions to receive interaction signals from a user interacting with the input device 102. In some embodiments, in response to the interaction signals, the computing system processor(s) 118 may provide instructions to the peripheral controller(s) 116 to perform actions.

In some embodiments, the memory 120 can store data associated with indicator(s) of the computing system 104. For example, the computing system 104 may receive instructions to store data associated with the active indicator in the memory 120 corresponding to a position of an indicator, a clipboard item, or application-specific data, and the like. In some embodiments, data may be retrieved from the memory 120 by the computing system processor(s) 118 to perform actions. For example, in some embodiments, actions include moving an active cursor from a saved location, pasting a clipboard item, drawing, or painting with an indicator designated to be a certain paintbrush or other design tool, and the like.

The peripheral controller(s) 116 may be configured to control an indicator on the display 114 of the computing system 104. In some cases, the peripheral controller(s) 116 may receive instructions from the computing system processor(s) 118 to perform various actions with respect to indicators on the display 114. In some embodiments, the computing system 104 includes more than one peripheral controller(s) 116 configured to control more than one indicator on the display 114 of the computing system 104. For example, the computing system 104 may include a first and second peripheral controller(s) 116 configured to control a first and second indicator, respectively. In this example, when a first indicator is set as the active indicator, the computing system 104 may receive instructions from the first peripheral controller(s) 116 to control the first indicator. Similarly, when a second indicator is set as the active indicator, the computing system 104 may receive instructions from the second peripheral controller(s) 116 to control the second indicator. In some embodiments, the computing system 104 may include a third, fourth, fifth, . . . . Nth input device controller to provide instructions to the computing system 104 to control a Nth indicator on the display 114.

The display 114 of the computing system 104 may be any type of display element configured to render an image on a screen, such as a liquid crystal display (LCD), a micro-light emitting diode (mLED) display, an organic light emitting diode (OLED) display, or the like. In some embodiments, the display 114 may be integrated within the computing system 104, such as integrated with a monitor. In other cases, the display 114 may be an external display that connects to or otherwise receives output from the computing system 104. Although illustrated as a singular element, the display 114 may be implemented as a plurality of homogeneous or heterogenous displays. In some cases where the computing system 104 includes multiple displays, the output of the computing system may be extended across the displays. Additionally, or alternatively, at least one display may replicate the output of another display. In some examples, a user may navigate between the multiple displays using an indicator. As illustrated, the computing system 104 may be a single computing system that can include a number of elements. However, in some cases, the computing system 104 may include multiple devices. For example, the computing system 104 may include one device that includes that includes a central processing unit and a graphics processing unit, another device that includes a display, etc.

### Example Multi-Indicator Input Control Devices

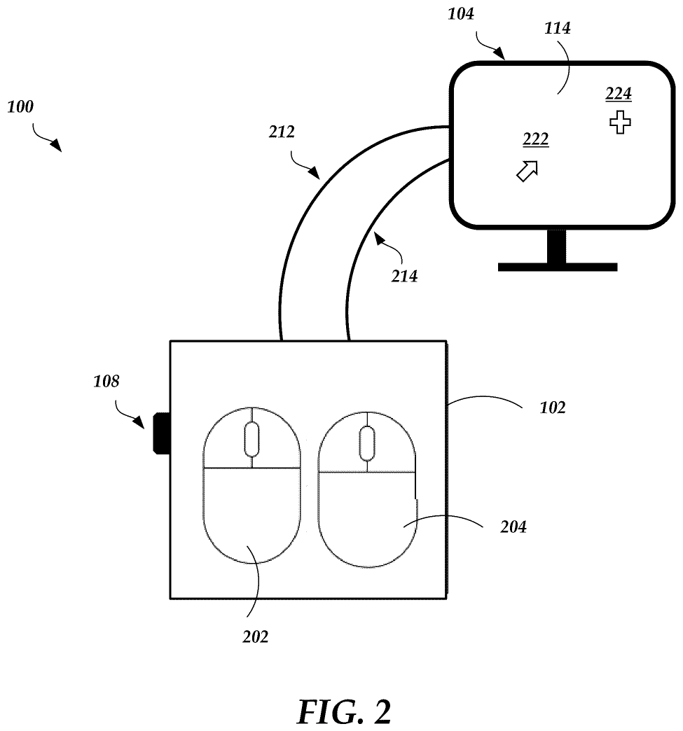

FIG. 2 illustrates an input device 102 that uses multiple controllers to control multiple indicators on a display of a computing system within computing environment 100. In some embodiments, the computing system 104 may be configured to receive instructions from one controller at a time from the input device 102. In other words, the computing system 104 may be “aware” of a single input device 102. Accordingly, although the input device 102 may house both a first and second controller, the input device 102 may communicate instructions to the computing system 104 using one of the controllers at a time. The controller selected to communicate the instructions may depend on the active indicator to be controlled on the display 114 of the computing system 104.

It is noted that the illustration in FIG. 2 of the first controller 202 and second controller 204 are intended to graphically illustrate the integration of multiple controllers within the input device 102 rather than a literal integration of separate hardware elements, such as two hardware mice. In other words, an implementation of the input device 102 may externally appear similar if not identical to mice that do not implement the embodiments disclosed herein. In some cases, the external representation of the input device 102 may appear as a single mouse with one or more extra user interface elements for controlling selection of an active indicator.

As shown in FIG. 2, the input device 102 includes a first controller 202 and second controller 204. In some embodiments, the input device 102 may be communicatively coupled to the computing system 104 via communication link 212. Communication link 212 may be any type of connection between the input device 102 and the computing system 104, such as a wired connection. Communication link 212 between the input device 102 and computing system 104 is not limited to wired connections but may include wireless communication such as BLUETOOTH®, Wi-Fi®, according to an IEEE 802 standard, etc. Further, in some cases, the communication link 212 may be or may include a network, such as the Internet. In some cases, communication link 212 may be used by both the input device 102 and the computing system 104 to send and receive instructions corresponding to controlling indicator(s) on the display 114. It is noted that although communication link 212 and communication link 214 are illustrated separately in FIG. 2, communication link 212 and communication link 214 may be a single link, such as a single wire, etc. It is noted that the two separate communication links 212 and 214 are intended to illustrate communication from two separate controllers over a connection to the computing system 104. In some embodiments, first controller 202 may be configured to provide instructions via communication link 212 to the computing system 104 to control a first indicator 222 while second controller 204 is inactive. For example, although the user interaction element(s) 106 is not shown, the input device 102 may receive an interaction signal via the user interaction element(s) 106, such as a click, drag, or the like. In this case, in response to an interaction signal, first controller 202 may provide an instruction to the computing system 104 to perform an action with respect to the first indicator 222. First indicator 222 is considered the “active” indicator because it is being controlled by first controller 202 of the input device 102, whereas a second indicator 224 is considered the “inactive” indicator because it is not currently being controlled by the input device 102.

In some embodiments, the input device 102 may receive a switch control signal in response to interaction with the switch control element 108. In some embodiments, in response to the switch control signal, the input device 102 may set the first indicator 222 as inactive and the second indicator 224 as active. Second controller 204 may be configured to provide instructions via communication link 214 to the computing system 104 to control a second indicator 224 while first controller 202 is inactive. In some embodiments, the input device 102 may be communicatively coupled to the computing system 104 via communication link 214. Communication link 214 may be any type of connection between the input device 102 and the computing system 104, such as a wired connection. Communication link 214 between the input device 102 and computing system 104 is not limited to wired connections but may include wireless communication such as BLUETOOTH®, Wi-Fi®, according to an IEEE 802 standard, etc. Further, in some cases, the communication link 214 may be or may include a network, such as the Internet. In some cases, link 214 may be used by both the input device 102 and the computing system 104 to send and receive instructions corresponding to controlling indicator(s) on the display 114. In response to an interaction signal, second controller 204 may provide an instruction to the computing system 104 to perform an action with respect to the second indicator 224. Second indicator 224 is considered the “active” indicator because it is being controlled by second controller 204 of the input device 102, whereas a first indicator 222 is considered the “inactive” indicator because it is not currently being controlled by the input device 102.

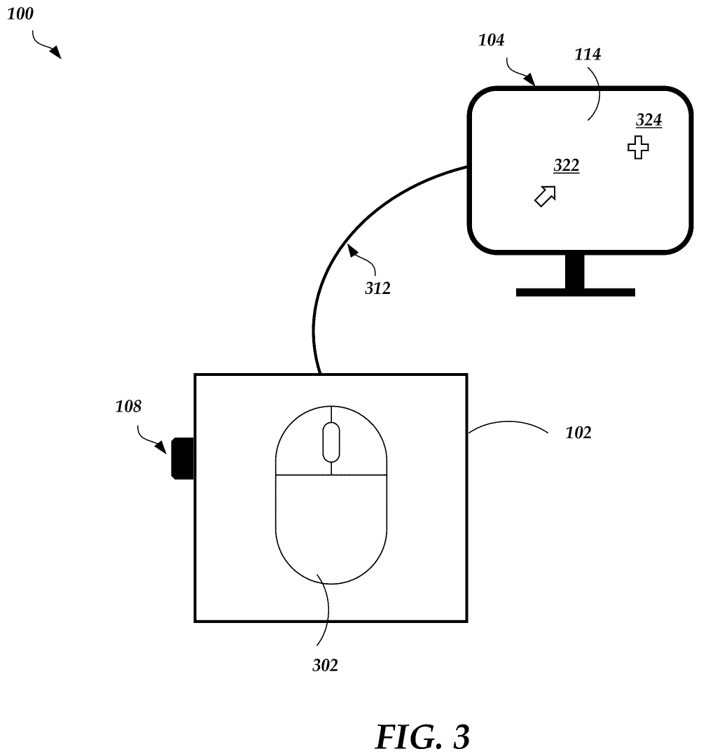

FIG. 3 illustrates an example input device 102 that includes a single controller to control multiple indicators on a display of the computing system 104 within a computing environment 100. The computing system 104 may be “aware” of a single input device 102. However, in this embodiment, a controller of the computing system 104 may receive and map instructions from the input device 102 to an active indicator of a plurality of indicators.

As shown in FIG. 3, the input device 102 includes an input device controller 302. Although not shown, input device 102 may include an input device processor. In some embodiments, the input device controller 302 or the input device processor 110 may be configured to provide instructions via communication link 312 to a controller of the computing system 104 to control a first indicator 322 or second indicator 324. The communication link 312 may include one or more of the embodiments described with respect to the communication link 212, 214. The input device 102 may receive an interaction signal via the user interaction element(s) 106, such as a click, drag, or the like. In some embodiments, input device controller 302 or the input device processor 110 provides instructions to the controller of the computing system 104. In some embodiments, controller may receive instructions from the input device controller 302 or the input device processor 110 and perform an action with respect to the active indicator. If first indicator 322 is active, interaction with the user interaction element(s) 106 may be mapped to the first indicator 322 on the display 114. In this case, first indicator 322 is considered the “active” indicator because the controller of the computing system 104 is configured to associate signals from input device controller 302 with the first indicator 322. On the other hand, if second indicator 324 is active, interaction with the user interaction element(s) 106 may be mapped to the first indicator 322 on the display 114. In some embodiments, interaction signals may be sent from the input device 102 to the computing system 104, such as via communication link 312. In this case, the computing system 104 may receive the interaction signals and perform further processing on the signal to correlate control with indicator(s) on the display 114.

In some embodiments, the input device 102 may receive a switch control signal in response to interaction with the switch control element 108. In some embodiments, in response to the switch control signal, the input device controller 302 of the input device 102 may send an instruction via communication link 312 to the controller of the computing system 104 to set the first indicator 322 as inactive and the second indicator 324 as active. Second indicator 324 is considered the “active” indicator because the controller of the computing system 104 is configured to associate signals from input device controller 302 with the second indicator 324.

### Example Active Indicator Control Process

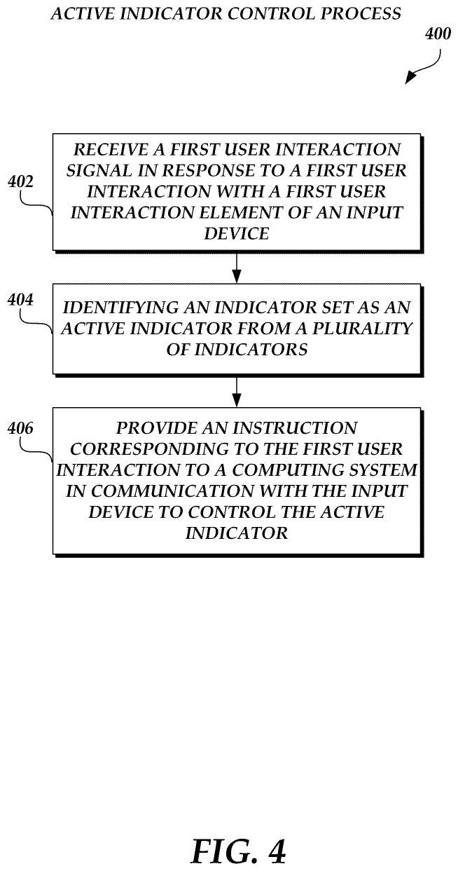

FIG. 4 presents a flowchart of an example active indicator control process 400 in accordance with certain embodiments. The process can be implemented by any system that can manage and control multiple indicators. The process 400, in whole or in part, can be implemented by, for example, an input device 102, a first input device controller 112, an input device processor 110, a computing system 104, and the like. Although any number of systems, in whole or in part, can implement the process 400, to simplify discussion the process 400 will be described with respect to particular systems.

The process 400 may begin at block 402 where, for example, the input device receives a first user interaction signal in response to a first user interaction with user interaction element(s) 106, such as a first user interaction element. In some embodiments, the first user interaction signal includes a signal generated by the switch control element 108 in response to the user interacting with a button on the input device 102, dragging a finger across a touch-sensitive surface (e.g., if input device 102 is a trackpad, or the like), moving the input device 102, providing a voice command to the input device 102, performing a gesture detectable by the input device 102, etc. For example, the input device 102 and/or computing system 104 may include a camera capable of detecting hand, face, body, etc. gestures indicative of an intent to interact with the input device 102 or an indicator controlled by the input device 102.

At block 404, the input device processor 110 identifies an indicator set as an active indicator from a plurality of indicators. In some cases, an active indicator may be an active cursor of a plurality of cursors. An active indicator may refer to an indicator on the display 114 of the computing system 104 that is actively being controlled by the input device 102. Further, in some cases, the active indicator is accentuated to distinguish from the plurality of non-active cursors. For example, accentuations may include highlighting, blinking, flashing, different colors, different sizes, etc. In some cases, an active indicator may be illustrated as a first icon and a non-active indicator may be illustrated as a second icon.

At block 406, the input device processor 110 provides an instruction corresponding to the first user interaction to the computing system 104 in communication with the input device to control the active indicator. In some embodiments, the input device processor 110 provides the instruction via the input device controller(s) 112. Further, the instruction may be provided to a peripheral controller(s) 116 of the computing system 104.

In some embodiments, in response to the first user interaction signal received at the block 402, a first input device controller 112 of the input device 102 may provide the instruction to the computing system 104 to control the active indicator. In some such cases, the first controller may be one of a plurality of controllers housed within 102 that correspond to the plurality of indicators. Depending on which indicator is set as active, the corresponding controller may provide instructions to the computing system 104 to control the active indicator. In this case, the first controller may provide a first instruction to the computing system to perform a first action with respect to the first indicator.

In certain embodiments, in response to the first user interaction signal received at the block 402, an input device processor 110 of the input device 102 may provide the instruction to the peripheral controller(s) 116 of the computing system 104. In some such cases, the peripheral controller(s) 116 of the computing system 104 may direct instructions from the input device processor 110 of input device 102 to an active indicator of the plurality of indicators. Depending on which indicator is set as active, the peripheral controller(s) 116 may provide instructions to control the active indicator. In this case, the input device processor 110 may provide a first instruction to the peripheral controller(s) 116 of the computing system to perform a first action with respect to the first indicator. Additionally, computing system 104 may include a first display and a second display. The first and second displays may be communicatively coupled such that an indicator may navigate between both displays. In some cases, an action may include moving the active indicator between a first display and a second display of computing system 104. A first indicator may be located on the first display of the computing system 104 and a second indicator may be located on the second display of computing system 104.

In some cases, data associated with the active indicator may be stored. For example, the instruction may cause the computing system 104 to store data associated with the active indicator in a memory of the computing system 104. Data associated with the active indicator may include metadata associated with the input device 102, such as a position of an indicator controlled by the input device 102 or a state of one or more user interaction element(s) 106. Additionally, or alternatively, the data may include user or application data, such as a clipboard item, highlighted text, selected items, and the like. In addition, the instruction may cause the computing system 104 to retrieve the stored data to perform the second action with respect to the second indicator based on the retrieved data. In some cases, the action performed with respect to the active indicator may utilize the retrieved data. For example, a clipboard item may be pasted at a particular location corresponding to the second indicator as part of a “paste” action of the active indicator.

In some cases, the indicator(s) may be designated for specific functions and/or areas of the display 114. For example, in some cases, indicator(s) may be restricted to a bounded area on the display 114 of the computing system 104, such as a window, an application, a screen, etc. For example, an indicator's movement may be locked to a certain area of display 114. In another case, a first indicator may be located within a client area of a window depicted on the display 114 of the computing system 104 and a second indicator may be located within a non-client area of the window depicted on the display 114 of the computing system 104. A client area may refer to a space inside a window boarder of an application where the content of the application is located. A non-client area may refer to the other areas of the application window where content is not located, such as the title bar, borders, minimize/maximize buttons, close button, etc.

### Example Active Indicator Switching Process

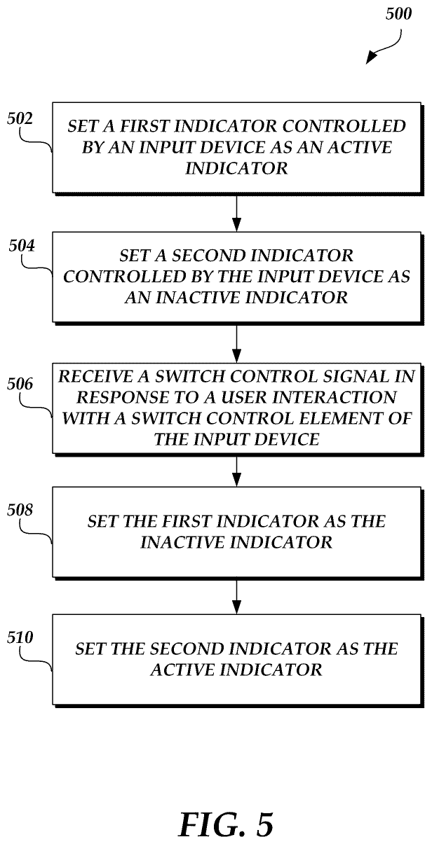

FIG. 5 presents a flowchart of an example active indicator switching process in accordance with certain embodiments. The process can be implemented by any system that can manage and control multiple indicators. The process 500, in whole or in part, can be implemented by, for example, an input device 102, an input device processor 110 of the input device 102, a computing system 104, and the like. Although any number of systems, in whole or in part, can implement the process 500, to simplify discussion the process 500 will be described with respect to particular systems.

The process 500 may begin at block 502 where, for example, an input device processor 110 of the input device 102 sets a first indicator controlled by the input device 102 as an active indicator. In some cases, the input device processor 110 of the input device 102 sets the first indicator as the active indicator by sending an active indicator identifier to the controller of the computing system that specifies which indicator controlled by the input device 102 is to be the active indicator. The input device 102 may control the active indicator in response to user interactions with the input device 102, or the switch control element 108 of the input device 102. In some cases, setting the second indicator as the active indicator comprises accentuating or otherwise visually emphasizing the first indicator. In some cases, accentuating the active indicator may include highlighting the indicator, causing the indicator to flash or blink, changing a speed or rate at which the indicator flashes or blinks, or any other visual effect that may help to focus the user's eye or attention to the active indicator. In some cases, the visual effect that emphasizes the active indicator is temporary. In other cases, the visual effect remains in effect until there is a change in the selection of the active indicator. Additionally, or alternatively, the one or more indicators that are inactive or not the active indicator may be deemphasized. Deemphasizing the one or more indicators may include making the inactive indicators dimmer, translucent, not bolded, not highlighted, or any other visual effect that may signify to the user that the one or more indicators are inactive or not currently selected as the active indicator.

At block 504, the input device processor 110 of the input device 102 sets a second indicator controlled by the input device 102 as an inactive indicator. In some cases, the input device processor 110 of the input device 102 sets the second indicator as the inactive indicator by sending an inactive indicator identifier to the controller of the computing system. In some embodiments, all other indicators controlled by the input device 102 that are not the active indicator may be inactive. In some cases, setting the second indicator as the inactive indicator comprises visually deemphasizing the second indicator as explained above with respect to the block 502.

At block 506, the input device 102 may receive a switch control signal in response to a user interaction with a switch control element 108 of the input device 102. In some embodiments, the input device processor 110 of the input device 102 may receive the switch control signal. In some embodiments, the switch control signal includes interacting with a button on the input device 102, dragging a finger across a touch-sensitive surface (e.g., if the input device 102 is a trackpad, or the like), moving the input device 102, providing a voice command to the input device 102, performing a gesture detectable by the input device 102, etc. For example, the user interaction with the switch control element 108 may include at least one of interacting with a button, providing a voice command, performing a gesture, gazing at a particular location detectable by an eye-tracking device, etc. In some cases, the switch control element 108 may be implemented in a separate housing from the input device 102. For example, the switch control element 108 may be implemented by a camera that is separate from the input device 102, but which may provide a signal to the input device 102 indicating a user's desired to switch active indicators based, for example, on a user's gaze or focus.

At block 508, the input device processor 110 of the input device 102 sets the first indicator controlled by the input device 102 as an inactive indicator. In some cases, the input device processor 110 of the input device 102 sets the second indicator as the active indicator by sending an inactive indicator identifier to the controller of the computing system. In some cases, setting the first indicator as the inactive indicator comprises visually deemphasizing the first indicator.

At block 510, the input device processor 110 of the input device 102 sets the second indicator controlled by the input device 102 as the active indicator. In some cases, the input device processor 110 of the input device 102 sets the second indicator as the active indicator by sending an active indicator identifier to the controller of the computing system. In some cases, setting the second indicator as the active indicator comprises accentuating the first indicator. In some cases, setting the first indicator as the active indicator comprises visually emphasizing the second indicator.

In some cases, the input device processor 110 may cause an action to be performed with respect to the second indicator in response to an interaction signal. In some cases, causing an action to be performed with respect to the second indicator comprises transmitting an active indicator identifier corresponding to the second indicator to the computing system with or prior to sending an instruction corresponding to the action to the computing system 104.

In some cases, the indicator(s) may be designated for specific functions and/or areas of the display 114. This may occur when the computing system 104 includes more than one display 114. For example, in some cases, indicator(s) may be restricted to a bounded area on the display 114 of the computing system 104, such as a window, an application, a screen, etc. In another case, a first indicator may be located within a client area of a window depicted on the display 114 of the computing system 104 and a second indicator may be located within a non-client area of the window depicted on the display 114 of the computing system 104.

Although the process 500 has been described with respect to a first and second indicator, it should be understood that the process may be performed with a plurality of indicators of computing system 104. For example, a user may switch control of a plurality of indicators using the input device 102. In some cases, a plurality of indicators may be designed and/or restricted to certain areas of the display 114. In some cases, indicators may include different icons and perform different functions, such as within applications or programs.

### EXAMPLE EMBODIMENTS

Some example enumerated embodiments of the present disclosure are recited in this section in the form of methods, systems, and non-transitory computer-readable media, without limitation.

One aspect of the disclosure provides an input device comprising: a first user interaction element to interact with an active indicator on a display of a computing system; a switch control element 108 to modify selection of an indicator as the active indicator; a first controller to provide instructions to the computing system to control a first indicator on the display of the computing system; a second controller to provide instructions to the computing system to control a second indicator on the display of the computing system; and a processor to: receive a first user interaction signal in response to a first user interaction with the first user interaction element; in response to the first user interaction signal, use the first controller to provide a first instruction to the computing system to perform a first action with respect to the first indicator, wherein the first indicator is set as the active indicator and the second indicator is set as an inactive indicator; receive a switch control signal in response to a second user interaction, the second user interaction with the switch control element; set the first indicator as the inactive indicator and set the second indicator as the active indicator in response to the switch control signal; receive a second user interaction signal in response to a third user interaction with the first user interaction element; and in response to the second user interaction signal, use the second controller to provide a second instruction to the computing system to perform a second action with respect to the second indicator.

The input device of the preceding paragraph can include any sub-combination of the following features: where setting the second indicator as the active indicator comprises accentuating the second indicator; where the first instruction includes instructions to store data associated with the active indicator in a memory of the computing system, and wherein the data associated with the active indicator includes a position, a clipboard item, or application-specific data; where the second instruction includes instructions to retrieve the stored data to perform the second action with respect to the second indicator based on the retrieved data; where the second user interaction with the switch control element includes at least one of interacting with a button, providing a voice command, performing a gesture, or gazing at a particular location detectable by an eye-tracking device; where the display comprises a first display and a second display, and wherein the first indicator is displayed on a first display of the computing system and the second indicator is displayed on a second display of the computing system; where the second indicator is restricted to a bounded area on the second display of the computing system; where the first action with respect to the first indicator includes moving the first indicator between the first display and the second display; where the first indicator is within a client area of a window depicted on the display of the computing system and the second indicator is within a non-client area of the window depicted on the display of the computing system; and where the first indicator is illustrated as a first icon and the second indicator is illustrated as a second icon.

Another aspect of the disclosure provides an input device, comprising: a first user interaction element to interact with an active indicator on a display of a computing system; a switch control element to modify selection of an indicator as the active indicator; a processor to provide instructions to a controller of the computing system to control at least one of a first indicator or a second indicator of the computing system, the processor to: receive a first user interaction signal in response to a first user interaction, the first user interaction with the first user interaction element; in response to the first user interaction signal, provide a first instruction to the controller of the computing system to perform a first action with respect to the first indicator, wherein the first indicator is set as the active indicator and the second indicator is set as an inactive indicator; receive a switch control signal in response to a second user interaction, the second user interaction with the switch control element; set the first indicator as the inactive indicator and set the second indicator as the active indicator in response to the switch control signal; receive a second user interaction signal in response to a third user interaction with the first user interaction element; and in response to the second user interaction signal, provide a second instruction to the controller of the computing system to perform a second action with respect to the second indicator.

The input device of the preceding paragraph can include any sub-combination of the following features: where the first instruction causes the computing system to store data associated with the active indicator in a memory of the computing system; where the second instruction causes the computing system to retrieve the stored data and to perform the second action with respect to the second indicator based on the retrieved data; where the display comprises a first display and a second display, and wherein the first indicator is displayed on a first display of the computing system and the second indicator is displayed on a second display of the computing system; where the second indicator is restricted to a bounded area on the second display of the computing system; where the first indicator is within a client area of a window depicted on the display of the computing system and the second indicator is within a non-client area of the window depicted on the display of the computing system; and where setting the second indicator as the active indicator comprises sending an active indicator identifier to the controller of the computing system.

Yet another aspect of the disclosure provides a method comprising: by an input device of a computing system, the input device to control at least a first indicator on a first display of the computing system and a second indicator on a second display of the computing system, receiving a first user interaction signal in response to a first user interaction, the first user interaction with a first user interface element of the input device; causing a first action to be performed with respect to the first indicator in response to the first user interaction signal, wherein the first indicator is set as an active indicator and the second indicator is set as an inactive indicator; receiving a switch control signal in response to a second user interaction, the second user interaction with a switch control element of the input device, the switch control element to modify the active indicator; setting the first indicator as the inactive indicator and setting the second indicator as the active indicator in response to the switch control signal; receiving a second user interaction signal in response to a third user interaction, the third user interaction with the first user interface element of the input device; and causing a second action to be performed with respect to the second indicator in response to the second user interaction signal.

The method of the preceding paragraph can include any sub-combination of the following features: where setting the second indicator as the active indicator comprises visually emphasizing the second indicator and visually deemphasizing the first indicator; and where causing the second action to be performed with respect to the second indicator comprises transmitting an active indicator identifier corresponding to the second indicator to the computing system with or prior to sending an instruction corresponding to the second action to the computing system.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of electronic devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable electronic device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached FIGs. should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

1. An input device comprising:
a housing, comprising:
a first user interaction element to interact with an active indicator on a display of a computing system;
a switch control element to receive physical user interaction to modify selection of an indicator as the active indicator, the switch control element comprising at least one button to modify selection of the indicator;
a first controller to provide instructions to the computing system to control a first indicator within a first application on the display of the computing system,
wherein the first indicator is a first cursor type associated with the first application, and
wherein the first indicator is located within a client area of the first application on the display of the computing system;
a second controller to provide instructions to the computing system to control a second indicator within a second application on the display of the computing system,
wherein the second indicator is a second cursor type associated with the second application, and
wherein the second indicator is located within a client area of the second application on the display of the computing system; and
a processor to:
receive a first user interaction signal in response to a first user interaction with the first user interaction element;
in response to the first user interaction signal, use the first controller to provide a first instruction to the computing system to perform a first action with respect to the first indicator within the client area of the first application, wherein the first indicator is set as the active indicator and the second indicator is set as an inactive indicator;
receive a switch control signal in response to a second user interaction, the second user interaction with the switch control element;
set the first indicator as the inactive indicator and set the second indicator as the active indicator in response to the switch control signal;
receive a second user interaction signal in response to a third user interaction with the first user interaction element; and
in response to the second user interaction signal, use the second controller to provide a second instruction to the computing system to perform a second action with respect to the second indicator within the client area of the second application.

2. The input device of claim 1, wherein setting the second indicator as the active indicator comprises accentuating the second indicator.

3. The input device of claim 1, wherein the first instruction includes instructions to store data associated with the active indicator in a memory of the computing system, and wherein the data associated with the active indicator includes a position, a clipboard item, or application-specific data.

4. The input device of claim 3, wherein the second instruction includes instructions to retrieve the stored data to perform the second action with respect to the second indicator based on the retrieved data.

5. The input device of claim 1, wherein the second user interaction with the switch control element includes at least one of interacting with a button or, performing a gesture.

6. The input device of claim 1, wherein the display comprises a first display and a second display, and wherein the first indicator is displayed on a first display of the computing system and the second indicator is displayed on a second display of the computing system.

7. The input device of claim 6, wherein the second indicator is restricted to a bounded area on the second display of the computing system.

8. The input device of claim 6, wherein the first action with respect to the first indicator includes moving the first indicator between the first display and the second display.

9. The input device of claim 1, wherein the first indicator is within a client area of a window depicted on the display of the computing system and the second indicator is within a non-client area of the window depicted on the display of the computing system.

10. The input device of claim 1, wherein the first indicator is illustrated as a first icon and the second indicator is illustrated as a second icon.

11. An input device, comprising:
a housing, comprising:
a first user interaction element to interact with an active indicator on a display of a computing system;
a switch control element to receive physical user interaction to modify selection of an indicator as the active indicator, the switch control element comprising at least one button to modify selection of the indicator; and
a processor to provide instructions to a controller of the computing system to control at least one of a first indicator or a second indicator of the computing system,
wherein the first indicator is a first cursor type associated with a first application and the second indicator is a second cursor type associated with a second application, and
wherein the first indicator is located within a client area of the first application on the display of the computing system and the second indicator is located within a client area of the second application on the display of the computing system;
the processor to:
receive a first user interaction signal in response to a first user interaction, the first user interaction with the first user interaction element;
in response to the first user interaction signal, provide a first instruction to the controller of the computing system to perform a first action with respect to the first indicator within the client area of the first application, wherein the first indicator is set as the active indicator and the second indicator is set as an inactive indicator;
receive a switch control signal in response to a second user interaction, the second user interaction with the switch control element;
set the first indicator as the inactive indicator and set the second indicator as the active indicator in response to the switch control signal;
receive a second user interaction signal in response to a third user interaction with the first user interaction element; and
in response to the second user interaction signal, provide a second instruction to the controller of the computing system to perform a second action with respect to the second indicator within the client area of the second application.

12. The input device of claim 11, wherein the first instruction causes the computing system to store data associated with the active indicator in a memory of the computing system.

13. The input device of claim 12, wherein the second instruction causes the computing system to retrieve the stored data and to perform the second action with respect to the second indicator based on the retrieved data.

14. The input device of claim 11, wherein the display comprises a first display and a second display, and wherein the first indicator is displayed on a first display of the computing system and the second indicator is displayed on a second display of the computing system.

15. The input device of claim 14, wherein the second indicator is restricted to a bounded area on the second display of the computing system.

16. The input device of claim 11, wherein the first indicator is within a client area of a window depicted on the display of the computing system and the second indicator is within a non-client area of the window depicted on the display of the computing system.

17. The input device of claim 11, wherein setting the second indicator as the active indicator comprises sending an active indicator identifier to the controller of the computing system.

18. A method comprising:
by an input device of a computing system, the input device to control at least a first indicator on a first display of the computing system and a second indicator on a second display of the computing system,
wherein the first indicator is a first cursor type associated with a first application and the second indicator is a second cursor type associated with a second application, and
wherein the first indicator is located within a client area of the first application on the display of the computing system and the second indicator is located within a client area of the second application on the display of the computing system;
receiving a first user interaction signal in response to a first user interaction, the first user interaction with a first user interface element in a housing of the input device;
causing a first action to be performed with respect to the first indicator in response to the first user interaction signal within the client area of the first application, wherein the first indicator is set as an active indicator and the second indicator is set as an inactive indicator;
receiving a switch control signal in response to a second user interaction, the second user interaction with a switch control element in the housing of the input device, the switch control element to receive physical user interaction to modify the active indicator, the switch control element comprising at least one button to modify selection of the indicator;
setting the first indicator as the inactive indicator and setting the second indicator as the active indicator in response to the switch control signal;
receiving a second user interaction signal in response to a third user interaction, the third user interaction with the first user interface element of the input device; and
causing a second action to be performed with respect to the second indicator in response to the second user interaction signal within the client area of the second application.

19. The method of claim 18, wherein setting the second indicator as the active indicator comprises visually emphasizing the second indicator and visually deemphasizing the first indicator.

20. The method of claim 18, wherein causing the second action to be performed with respect to the second indicator comprises transmitting an active indicator identifier corresponding to the second indicator to the computing system with or prior to sending an instruction corresponding to the second action to the computing system.
